(19) United States
(12) Patent Application Publication
(10) Pub. No.: US 2008/0198116 A1
(43) Pub. Date: Aug. 21, 2008

(54) LIQUID CRYSTAL DISPLAY DEVICE AND METHOD OF DRIVING THE SAME

(76) Inventor: Tae-Sung Kim, Suwon-si (KR)

Correspondence Address: F. CHAU & ASSOCIATES, LLC, 130 WOODBURY ROAD, WOODBURY, NY, 11797, US

(21) Appl. No.: 11/677,625

(22) Filed: Apr. 6, 2007

(30) Foreign Application Priority Data
Apr. 7, 2006 (KR) 10-2006-31940

(51) Int. Cl. G09G 3/36

(52) U.S. Cl. 345/89

(57) ABSTRACT

A liquid crystal display device includes a timing controller, a data driver, a gate driver and a liquid crystal panel. The timing controller receives an image data signal to output a first control signal, a second control signal and a data signal corresponding to the image data signal. The data driver outputs first and second gray scale signals having different gray scale levels in response to the first control signal and the data signal. The gate driver outputs a gate signal in response to the second control signal. The liquid crystal panel includes a plurality of pixels aligned in a matrix and displays an image in response to the first gray scale signal, the second gray scale signal and the gate signal. Each of the pixels of the liquid crystal panel includes a first sub-pixel, to which the first and second gray scale signals are alternately applied in one frame unit, and a second sub-pixel, to which the first gray scale signal is applied.

### CROSS-REFERENCE TO RELATED PATENT APPLICATION

This application claims priority to Korean Patent Application No. 2006-31940, filed on Apr. 7, 2006, the contents of which are herein incorporated by reference in its entirety.

### BACKGROUND OF THE INVENTION

1. Technical Field

The present disclosure relates to a display device and, more particularly, to a liquid crystal display device capable of improving the display quality thereof and a method of driving the liquid crystal display device.

2. Discussion of Related Art

A liquid crystal display device includes two substrates coupled with each other while forming a predetermined space therebetween, and a liquid crystal layer interposed between the two substrates. The liquid crystal display device applies an electric field to the liquid crystal layer that aligns the liquid crystal molecules of the liquid crystal layer to control the polarization of incident light, thereby displaying images.

In liquid crystal display devices employing a large-sized liquid crystal panel, the image may exhibit some distortion depending on the viewing angle, and the picture quality may be degraded. In addition, the contour of the image may be blurred when the liquid crystal display device displays moving pictures.

### SUMMARY OF THE INVENTION

In an exemplary embodiment of the present invention, a liquid crystal display device includes a timing controller, a data driver, a gate driver and a liquid crystal panel. The timing controller receives an external image data signal to output a first control signal a second control signal and a data signal corresponding to the image data signal. The data driver outputs first and second gray scale signals having different gray scale levels in response to the first control signal and the data signal. The gate driver outputs a gate signal in response to the second control signal. The liquid crystal panel includes a plurality of pixels aligned in a matrix and displays an image in response to the first gray scale signal, the second gray scale signal and the gate signal

Each of the pixels of the liquid crystal panel, according to an exemplary embodiment of the present invention, includes a first sub-pixel and a second sub-pixel. The first and second gray scale signals are alternately applied to the first sub-pixel from the data driver corresponding to frames of the image data signal. The first gray scale signal is applied to the second sub-pixel from the data driver.

In an exemplary embodiment of the present invention, a method of driving a liquid crystal display device is provided. The method includes: receiving an image data signal to output a first control signal, a second control signal and a data signal corresponding to the image data signal; outputting a first gray scale signal in response to the first control signal and the data signal in one frame unit, outputting a second gray scale having a gray scale level different from that of the first gray scale signal in response to the first control signal and the data signal in every two frames, outputting a first gate signal activated for every frame of the image data signal and outputting a second gate signal activated for every two frames of the image data signal in response to the second control signal; displaying an image in response to the first gray scale signal, the second gray scale signal and the gate signal,

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a block diagram showing a liquid crystal display device according to an exemplary embodiment the present invention.

FIGS. 2A and 2B are views showing a pixel of the liquid crystal panel shown in FIG. 1, according to an exemplary embodiment of the present invention.

FIG. 3 is a block diagram showing the gate driver 500 of FIG. 1, according to an exemplary embodiment of the present invention.

FIGS. 4A and 4B are timing diagrams showing driving signals in connection with FIGS. 2A and 2B.

FIG. 5 is a view showing images displayed on a liquid crystal panel according to an exemplary embodiment of the present invention.

FIG. 6 is a block diagram of a liquid crystal display device according to an exemplary embodiment of the present invention.

### DESCRIPTION OF EXEMPLARY EMBODIMENTS

Hereinafter, exemplary embodiments of the present invention will be described in detail with reference to the accompanying drawings.

In an exemplary embodiment of the present invention, a liquid crystal display device employs a vertical alignment mode of liquid crystal and may improve side visibility. In the vertical alignment mode, liquid crystal molecules are vertically distributed when the electric field is not applied to the liquid crystal layer. The liquid crystal molecules are aligned perpendicularly with respect to the electric field when the voltage is applied to the liquid crystal layer. For example, a super-patterned vertical alignment (S-PVA) mode divides a pixel into two sub-pixels wherein the charging rate of a first liquid crystal capacitor for the first sub-pixel is different from the charging rate of a second liquid crystal capacitor for the second sub-pixel. According to an exemplary embodiment of the present invention, a liquid crystal display device includes an S-PVA mode and the difference in charge rate for the first and second sub-pixels results in a transmittance difference, and the side visibility of the liquid crystal display device may be improved.

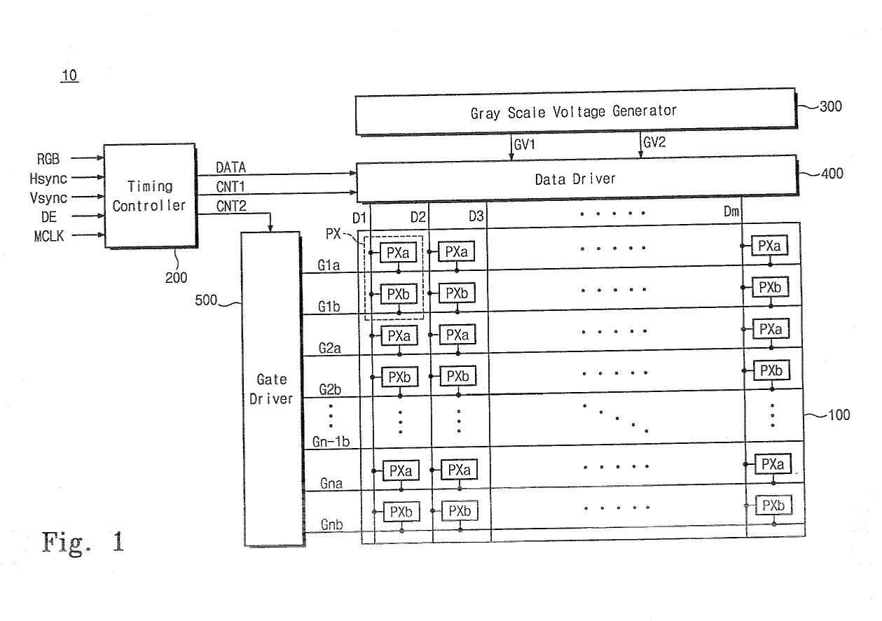

FIG. 1 is a block diagram showing a liquid crystal display device according to an exemplary embodiment the present invention.

Referring to FIG. 1 the liquid crystal display device 10 includes a liquid crystal panel 100 displaying images, a timing controller 200 outputting control signals, a gray scale voltage generator 300 outputting gray scale voltage signals, a data driver 400 outputting gray scale signals, and a gate driver 500 outputting gate driving signals.

The liquid crystal panel 100 includes a first substrate having a common electrode and a second substrate having pixel electrodes. A liquid crystal is interposed between the first and second substrates. The second substrate having the pixel electrodes includes a plurality of data lines D1-Dm, a plurality of gate lines G1a-Gnb, and a plurality of pixels PX aligned in the is form of a matrix and electrically connected to the data and gate lines D1-Dn and G1a-Gnb.

Each of the pixels PX includes a first sub-pixel PXa and a second sub-pixel PXb, which are electrically connected to a data line D1 and two gate lines G1a and G1b. The data lines D1-Dm may be aligned in a column direction of the liquid crystal panel 100 and may be substantially parallel to each other, and the gate lines G1-Cn may be aligned in a row direction of the liquid crystal panel 100 and may be substantially parallel to each other.

The timing controller 200 receives image data signals RGB a horizontal synchronous signal Hsync, a vertical synchronous signal Vsync, a data enable signal DE and a clock signal MCLK, for example, from an external source (not shown).

The timing controller 200 outputs a data signal DATA having the data format converted to be suitable for the standard of the liquid crystal panel 10O, and first and second control signals CNT1 and CNT2. The data signal DATA and the first control signal ONT1 are applied to the data driver 400, and the second control signal CNT2 is applied to the gate driver 500. The image data signals RGB applied to the timing controller 200 may have a frequency of about 60 Hz or about 120 Hz.

The gray scale voltage generator 300 outputs first and second gray scale voltage signals GV1 and GV2 related to the transmittance of the pixel PX in the liquid crystal panel 100. The first and second gray scale voltage signals GV1 and GV2 are applied to the data driver 400. In an exemplary embodiment of the present invention, the level of the first gray scale voltage signal GV1 is different from that of the second gray scale voltage signal GV2.

The data driver 400 outputs the first and second gray scale signals GA1 and GAS through the data lines D1-Dm of the liquid crystal panel 100 in response to the data signal DATA and first control signal CNT1, which are provided from the timing controller 200, and the first and second gray scale voltage signals GV1 and GV2, which are provided from the gray scale voltage generator 300.

The data driver 400 receives the data signal DATA related to one pixel row from the timing controller 200 and selects a gray scale voltage signal corresponding to the data signal DATA from the first and second gray scale voltage signals GV1 and GV2, which are provided from the gray scale voltage generator 300.

The data driver 400 converts the selected gray scale voltage signal into the first gray scale signal GA1 or the second gray scale signal GA2, which is an analog signal, and transmits the first gray scale signal GA1 or the second gray scale signal GA2 to the data lines D1-Dm.

In an exemplary embodiment of the present invention, the level of the first gray scale signal GA1 is different from that of the second gray scale signal GA2. For instance, when the level of the first gray scale signal GA1 is lower than that of the second gray scale signal GA2 a dark image may be displayed as the first gray scale signal GA1 is applied to the pixel PX of the liquid crystal air panel 100, and a bright image may be displayed as the second gray scale signal GA2 is applied to the pixel PX.

The first gray scale signal GA1 is applied to the first and second sub-pixels PXa and PXb of the liquid crystal panel 100, and the second gray scale signal GA2 is applied only to the first sub-pixel PXa of the liquid crystal panel 100. For instance, when the image data signal RGB is applied to the liquid crystal display device 10 during one frame period, the first gray scale signal GA1 is substantially simultaneously applied to the first and second sub-pixels PXa and PXb. The second gray scale signal GA2 is applied to the first sub-pixel PXa during the next one frame period. At this time, the first gray scale signal GA1, which has been applied to the first and second sub-pixels PXa and PXb, is maintained in the second sub-pixel PXb.

The gate driver 500 outputs the gate signals GS1a-GSnb through the gate lines GS1a-GSnb of the liquid crystal panel 100 in response to the second control signal CNT2 provided from the controller 200.

The gate signals GS1a-GSnb are applied to first and second sub-pixels PXa and PXb, respectively, turning on/off a thin film transistor corresponding to the first and second sub-pixels PXa and PXb. That is, the gate signals GS1a-GSnb determine when the first and second gray scale signals GA1 and GA2, which are output from the data driver 400, are applied to the first and second sub-pixels PXa and PXb.

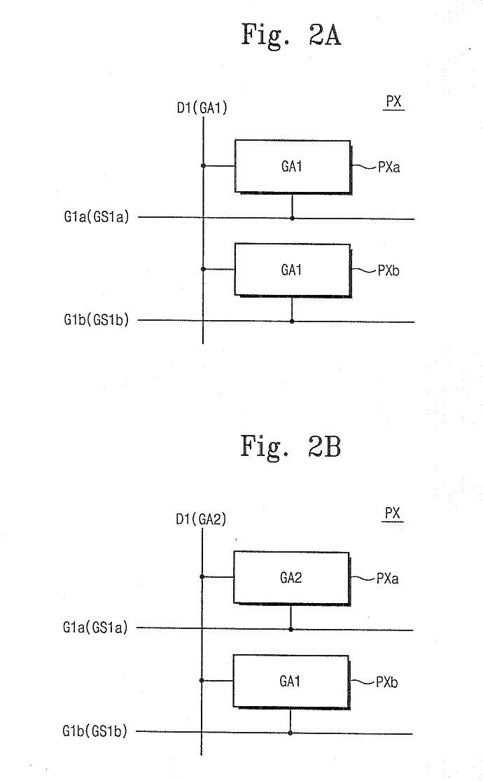

FIGS. 2A and 2B are views showing a pixel of the liquid crystal panel shown in FIG. 1, according to an exemplary embodiment of the present invention.

Referring to FIGS. 2A and 2B, each pixel PX includes first and second sub-pixels PXa and PXb, which are surrounded by one data line D1 and two gate lines G1a and G1b. The first sub-pixel PXa is connected to both the first data line D1 and the first gate line G1a, and the second sub-pixel PXb is connected to both the first data line D1 and the second gate line G1b.

FIG. 2A shows the gray scale signal applied to one pixel PX during one frame period of the image data signal RGB, which is applied to the liquid crystal display device 10, for example, from an external source. During one frame period of the image data signal RGB, the first gray scale signal GA1 is applied to the first and second sub-pixels PXa and PXb.

For example, when the activated first and second gate signals GS1a and GS1b are simultaneously input through the first and second gate lines G1a and G1b, the first and second sub-pixels PXa and PXb are substantially simultaneously turned on. Thus, the first gray scale signal GA1, which is provided from the data driver 400 through the first data line D1, is substantially simultaneously applied to the first and second sub-pixels PXa and PXb.

FIG. 2B shows the gray scale signal applied to one pixel PX after one frame period shown in FIG, 2A, that is, during the next frame period of the image data signal RGB. In the next frame period of the image data signal RGB, the second gray scale signal GA2 is applied to the first sub-pixel PXa, and the first gray scale signal GA1 as shown in FIG. 2A, is maintained in the second sub-pixel PXb.

For example, the activated first gate signal GS1a is input through the first gate line G1a, and the first sub-pixel PXa is turned on, and the second gate signal GS1b, which is input through the second gate line G1b, is not changed and the second sub-pixel PXb maintains a turn-off state.

Accordingly, the second gray scale signal GA2, which has been provided from the data driver 400 through the first data line D1, is applied only to the first sub-pixel PXa, At this time, the first gray scale signal GA1, which has been applied during the previous frame period is maintained in the second sub-pixel PXb.

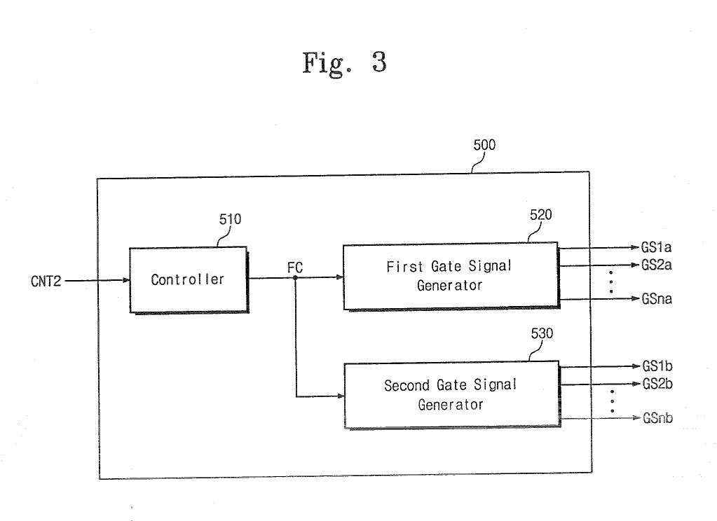

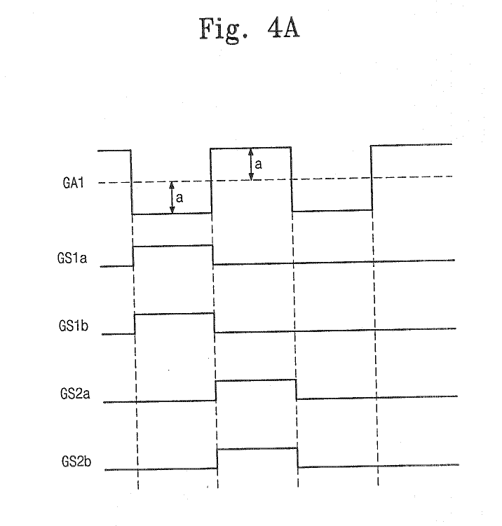

FIG. 3 is a block diagram showing the gate driver 500 of FIG. 1, according to an exemplary embodiment of the present invention.

Referring to FIG. 3, the gate driver 500 includes a controller 510 outputting frame control signals FC, a first gate signal generator 520 outputting first gate signals GS1a-GSna, and a second gate signal generator 530 outputting second gate signals GS1b-GSnb.

The controller 510 outputs the frame control signal FC, which corresponds to frames of the image data signal RGB, in response to the second control signal CNT2 output from the timing controller 200.

The first gate signal generator 520 outputs first gate signals GS1a to GSna, which are activated corresponding to each frame of the image data signal RGB, in response to the frame control signal FC, which is provided from the controller 510.

The second gate signal generator 530 outputs second gate signals GS1b-GSnb, which are activated corresponding to every two frames of the image data signal RGB, in response to the frame control signal FC, which is provided from the controller 510.

The first gate signals GS1a-GSna of the first gate signal generator 520 and the second gate signals GS1b-GSnb of the second gate signal generator 530 are applied to first and second sub-pixels PXa and PXb of the liquid crystal panel 100, respectively, thereby turning on/off the first and second sub-pixels PXa and PXb, respectively.

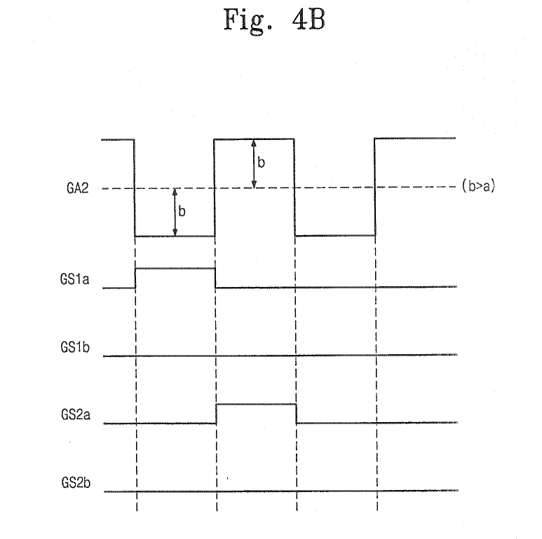

FIGS. 4A and 4B are timing diagrams showing driving signals in connection with FIGS. 2A and 2B.

Referring to FIG. 4A, the first gray scale signal GA1, which is provided from the data driver 400 through the first data line D1, has a predetermined level (a) and polarity thereof which is periodically changed.

If the activated first gate signal GS1a and the second gate signal GS1b are simultaneously input from the gate driver 500 through the first and second gate lines G1a and G1b, the first and second sub-pixels PXa and PXb are substantially simultaneously turned on. Accordingly, the first and second sub-pixels PXa and PXb are substantially simultaneously charged with the first gray scale signal GA1 having a negative polarity.

The gate signals GS1a-GSnb, which have been output from the gate driver 500, are sequentially activated corresponding to the pixels PX aligned in the column direction of the liquid crystal panel 100, thereby sequentially turning on the pixels PX.

Accordingly, the first and second sub-pixels PXa and PXb of the liquid crystal panel 100 are simultaneously charged with the first gray scale signal GA1 during one frame period of the image data signal RGB.

Referring to FIG. 4B, the second gray scale signal GA2, which is provided from the data driver 400 through the first data line D1, has a predetermined level (b) and the polarity thereof is periodically changed. In an exemplary embodiment of the present invention, the predetermined level (b) of the second gray scale signal GA2 is greater than the predetermined level (a) of the first gray scale signal GA1.

When the activated first gate signal GS1a is input from the gate driver 500 through the first gate line G1a the first sub-pixel PXa is turned on. When the second gate signal GS1b, which is not changed, is input from the gate driver 500 through the second gate line G1b, the second sub-pixel PXb is maintained in the turn-off state.

Thus, the first sub-pixel PXa is charged with the second gray scale signal GA2 having a negative polarity, and the first gray scale signal GA1 having the negative polarity, which has been charged during the previous frame, is maintained in the second sub-pixel PXb.

The first gate signals GS1a to GSna, which have been output from the gate driver 500, are sequentially activated in the column direction of the liquid crystal panel 100, thereby sequentially turning on the first pixels PXa, which air are aligned in the column direction of the liquid crystal panel 100.

In an exemplary embodiment of the present invention, the first sub-pixels PXa of the liquid crystal panel 100 are charged with the second gray scale signal GA2 during one frame period of the image data signal RGB, and the first gray scale signal GA1, which has been charged during the previous frame, is maintained in the second sub-pixels PXb.

Referring to FIGS. 4A and 48, the polarity of the first gray scale signal GA1, which is applied to the first sub-pixel PXa during one frame period of the image data signal RGB, is substantially identical to that of the second gray scale signal GA2 which is applied to the first sub-pixel PXa during the next frame period.

When the frame of the image data signal RGB is converted, the first gray scale signal GA1 charged in the first sub-pixel PXa is rarely converted into the second gray scale signal 0A2 and the charging time for the first sub-pixel PXa is sufficiently ensured.

In an exemplary embodiment of the present invention, the pixels PX of the liquid crystal panel 100 are charged with the first gray scale signal GA1 having a low gray scale level (a) during one frame period of the image data signal RGB, and the impulsive driving effect which allows a dark image to be displayed between normal images can be achieved when the liquid crystal display device 10 displays a moving picture, and the blurring phenomenon causing the contour of the image to be unclear or blurred may be prevented.

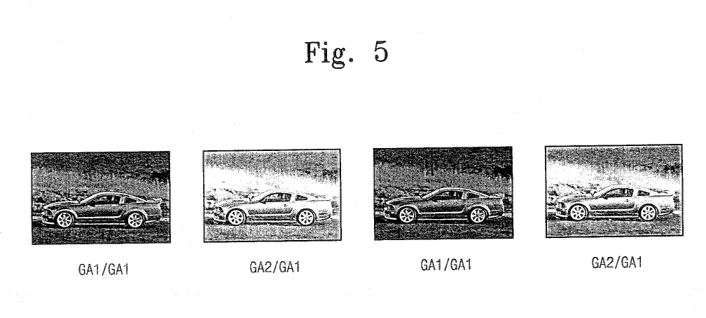

FIG. 5 is a view showing images displayed on the liquid crystal panel 100 of FIG. 1, according to an exemplary embodiment of the present invention.

Referring to FIG. 5, the first and second sub-pixels PXa and PXb are charged with first gray scale signals GA1 having low gray scale levels (a), respectively, during one frame period of the image data signal RGB, and a dark image may be displayed on the liquid crystal panel 100.

Meanwhile, the first sub-pixel PXa of the liquid crystal panel 100 is charged with the second gray scale signal GA2 having a high gray scale level (a) during the next frame period of the image data signal RGB. At this time, the first gray scale signal GA1 applied during the previous frame period is maintained in the second sub-pixel PXb of the liquid crystal panel 100, and a bright image may be displayed on the liquid crystal panel 100.

The liquid crystal panel 100 may repeatedly display the dark image and the bright image for every two frames of the image data signal RGB.

According to an exemplary embodiment of the present invention, each pixel of the liquid crystal panel 100 is divided into two sub-pixels. The gray scale signal having a low gray scale level is substantially simultaneously applied to the two sub-pixels during one frame period of the image data signal.

During the next frame period, the gray scale signal having the low gray scale level applied in the previous frame period is maintained in the first sub-pixel, and the second sub-pixel is charged with the gray scale signal having a high gray scale level.

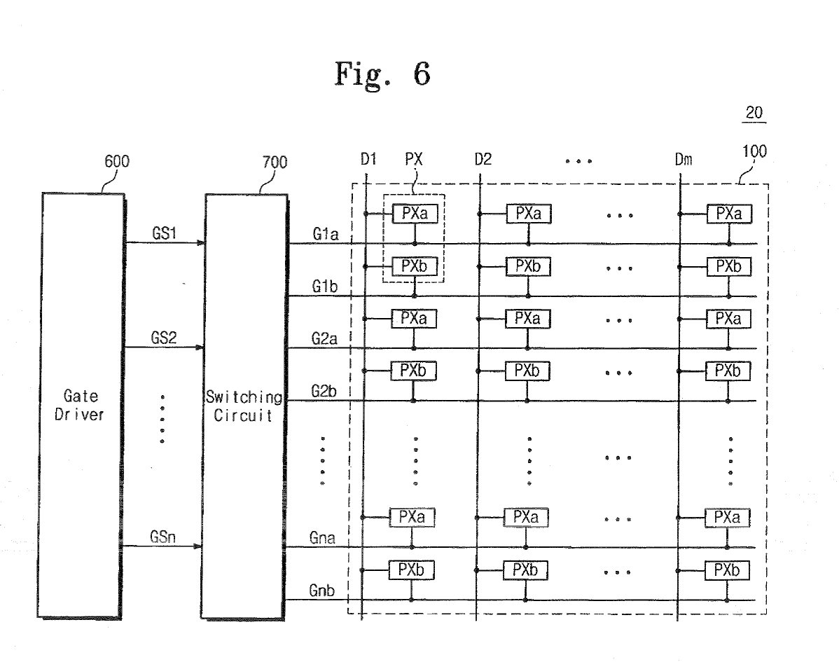

FIG. 6 is a block diagram of a liquid crystal display device according to an exemplary embodiment of the present invention. In FIG. 6, the same reference numerals denote the same elements as in FIG. 1, and further descriptions of these elements will be omitted in the interests of brevity.

Referring to FIG. 6, the liquid crystal display device 20 includes a liquid crystal panel 100 comprising a plurality of data lines D1˜Dm, a plurality of gate lines G1a˜Gnb and a plurality of pixels PX. Each of the pixels PX includes a first sub pixel PXa and a second sub pixel PXb. Odd gate lines G1a˜Gna of the gate lines G1a˜Gnb are electrically connected to the first sub pixels PAa, and even gate lines G1b˜Gnb of the gate lines G1a˜Gnb are electrically connected to the second sub pixels PXb.

The liquid crystal display device 20 includes a gate driver 600 and a switching circuit 700. The gate driver 600 outputs a plurality of gate signals GS1˜GSn. The switching circuit 700 receives the gate signals GS1˜GSn from the gate driver 600.

The switching circuit 700 outputs the gate signal GS1˜GSn to the odd gate lines G1a˜Gna in one frame unit. The gate signal GS1˜GSn are applied to the first sub pixels PXa through the odd gate lines G1a˜Gna, thereby turning on/off a thin film transistor constituting each of the first sub pixels PXa.

Also, the switching circuit 700 outputs the gate signal GS1˜GSn to the even gate lines G1b˜Gnb in every two frames. The gate signal GS1˜GSn are applied to the second sub pixels PXb through the even gate lines G1b˜Gnb, thereby turning on/off a thin film transistor constituting each of the second sub pixels PXb.

In an exemplary embodiment of the present invention, the switching circuit 700 may include switching elements (not shown) disposed between the gate driver 600 and the even gate lines G1b˜Cnb. The switching elements provide the gate signals GS1˜GSn to the even gate lines G1b˜Gnb in response to a selecting signal (not shown) having a high period in every two frames. That is, the switching circuit 700 may determine a point of time to drive the second sub pixels PXb in response to the selecting signal.

In an exemplary embodiment of the present invention, a side visibility of the liquid crystal panel can be improved and the blurring phenomenon can be removed, and the liquid crystal display device may have improved display quality.

Although exemplary embodiments of the present invention have been described in detail with reference to the accompanying drawings for the purpose of illustration, it is to be understood that the inventive processes and apparatus should not be construed as limited thereby. It will be apparent to those of ordinary skill in the art that various modifications to the foregoing exemplary embodiments can be made without departing from the scope of the invention as defined by the appended claims, with equivalents of the claims to be included therein.

What is claimed is:

1. A liquid crystal display device comprising:
a timing controller receiving an image data signal to output a first control signal a second control signal and a data signal corresponding to the image data signal;
a data driver outputting first and second gray scale signals having different gray scale levels in response to the first control signal and the data signal;
a gate driver outputting a gate signal in response to the second control signal; and
a liquid crystal panel including a plurality of pixels aligned in a matrix and displaying an image in response to the first gray scale signal, the second gray scale signal and the gate signal, wherein each of the pixels comprises;
a first sub-pixel to which the first and second gray scale signals are alternately applied in one frame unit; and
a second sub-pixel to which the first gray scale signal is applied.

2. The liquid crystal display device of claim 1, further comprising a gray scale voltage generator outputting a first gamma reference voltage having a first gamma value and a second gamma reference voltage having a second gamma value different from the first gamma value, wherein the data driver determines a gray scale level of the first and second gray scale signals in response to the first and second gamma reference voltages.

3. The liquid crystal display device of claim 2, wherein a gray scale level of the first gray scale signal is smaller than that of the second data gray scale signal.

4. The liquid crystal display device of claim 3, wherein a polarity of the first and second gray scale signals is the same, and wherein the polarity of the first and second gray scale signals is inverted in every two frames of the image data signal.

5. The liquid crystal display device of claim 1, wherein the gate signal comprises:
a first gate signal used to determine when to apply the first and second gray scale signals to the first sub-pixel; and
a second gate signal used to determine when to apply the first gray scale signal to the second sub-pixel.

6. The liquid crystal display device of claim 5, wherein the gate driver comprises:
a controller outputting a frame control signal corresponding to the frames of the image data signal in response to the second control signal;
a first gate signal generator outputting an activated first gate signal for every frame of the image data signal in response to the frame control signal; and
a second gate signal generator outputting an activated second gate signal for every two frames of the image data signal in response to the frame control signal.

7. The liquid crystal display device of claim 6, wherein each of the pixels further comprises:
a data line transmitting the first and second gray scale signals from the data driver;
a first gate line transmitting the first gate signal of the first gate signal generator to the first sub-pixel in one frame unit; and
a second gate line transmitting the second gate signal of the second gate signal generator to the second sub-pixel in every two frames.

8. The liquid crystal display device of claim 1, wherein the gate driver comprises a gate signal generator outputting the gate signal in response to the second control signal.

9. The liquid crystal display device of claim 8, wherein each of the pixels further comprises:
a data line transmitting the first and second gray scale signals from the data driver:
a first gate line receiving the gate signal in one frame unit to transmit the gate signal to the first sub-pixel; and
a second gate line receiving the gate signal in every two frames to transmit the gate signal to the second sub-pixel.

10. The liquid crystal display device of claim 8, further comprising a gate signal switching circuit supplying the gate signal to the first gate lines in one frame unit and supplying the gate signal to the second gate lines in every two frames.

11. The liquid crystal display device of claim 1, wherein the image data signal has a frequency of about 120 Hz or about 60 Hz.

12. A method of driving a liquid crystal display device, the method comprising:
receiving an image data signal to output a first control signal a second control signal and a data signal corresponding to the image data signal;
outputting a first gray scale signal in response to the first control signal and the data signal in one frame unit;
outputting a second gray scale having a gray scale level different from that of the first gray scale signal in response to the first control signal and the data signal in every two frames;
outputting a first gate signal activated for every frame of the image data signal and outputting a second gate signal activated for every two frames of the image data signal in response to the second control signal; and
displaying an image in response to the first gray scale signal, the second gray scale signal and the gate signal.

13. The method of claim 12, wherein the outputting of the first and second gate signals comprises:
outputting a frame control signal corresponding to frames of the image data signal in response to the second control signal; and
outputting the first and second gate signals in response to the frame control signal.

14. The method of claim 12, wherein a polarity of the first and second gray scale signals is the same, and wherein the polarity of the first and second gray scale signals is inversed in every two frames of the image data signal.

15. The method of claim 121 wherein a gray scale level of the first gray scale signal is smaller than that of the second gray scale signal.
